(19) United States
(12) Patent Application Publication
(10) Pub. No.: US 2006/0272100 A1
(43) Pub. Date: Dec. 7, 2006

(54) Fireproof non-woven fabric, method of manufacturing thereof and mattress cover obtained thereby

(75) Inventor: Paolo Barberis Canonico, Batley West Yorkshire (GB)

Correspondence Address: BACON & THOMAS, PLLC, 625 SLATERS LANE, FOURTH FLOOR, ALEXANDRIA, VA, 22314, US

(73) Assignee: SOLTEX INC.

(21) Appl. No.: 11/142,270

(22) Filed: Jun. 2, 2005

(51) Int. Cl. C11D 3/00

(52) U.S. Cl. 8/115.51

(57) ABSTRACT

A fireproof non-woven fabric, its method of manufacturing and a mattress cover obtained with said fireproof non-woven fabric in order to comply with TB 603 regulations issued by the State of California, U.S.A., said non-woven fabric comprising cellulose fibers, optionally synthetic fibers, synthetic yarns and at least a fireproof agent, said cellulose fibers and said synthetic fibers forming a blend wherein the ratios between cellulose fibers and synthetic fibers are variable, respectively, between 95% and 100% and between 5% and 0% by weight with respect to the blend, and being impregnated with said fireproof agent that includes phosphorus and nitrogen salts.

### FIELD OF THE INVENTION

The invention concerns a fireproof non-woven fabric, its method of manufacturing and a mattress cover obtained with said fireproof non-woven fabric. More precisely, the invention concerns a fireproof non-woven fabric, its method of manufacturing and a mattress cover obtained with said fireproof non-woven fabric in order to comply with TB 603 (Technical Bulletin 603) regulations issued by the Bureau of Home Furnishings and Thermal Insulation of the Department of Consumer Affairs of the State of California, U.S.A.; the aforesaid regulations, entitled “Requirements and Test Procedure for Resistance of a Residential Mattress/Box Spring Set to a Large Open-Flame”, has been issued to quantify and regulate the flammability resistance performance of mattresses in an attempt to reduce the number of deaths due to fires breaking out inside private houses, hotels and institutional facilities such as hospitals and rest homes. The reference TB 603 regulations specifies that a barrier fitted to prevent the fire propagation to the whole mattress must be realized.

### DESCRIPTION OF THE PRIOR ART

From international patent application WO 2005/012617 in the name of E.I. DUPONT DE NEMOURS AND COMPANY—U.S.A. published on Feb. 10, 2005 a single layer non-woven fabric containing cellulose fibers as well as the use of said single layer non-woven fabric as a fire-blocking component of mattresses meeting the requirements of TB 603 regulations are known. The drawback of the solution disclosed in the aforesaid application resides in that such single layer non-woven fabric is incorporated between the stuffing and the outer cover, thereby, however, not solving the flammability problem of the mattress cover itself; as a matter of fact, the non-woven fabric according to WO 2005/012617 is not fit for being used as outer cover substantially because it does not have acceptable aesthetic and finishing features.

Moreover, non-woven fabrics having flame retardant properties are known in literature, said non-woven fabrics comprising cellulose fibers in which at least a phosphorus-containing flame retardant compound is incorporated (see, for instance, U.S. Pat. No. 5,609,950 in the name of CHEMIEFASER LENZING AG-AT granted on Mar. 11, 1997 and JP patent application no. 2000-328418 in the name of KUREHA SENI KK-JP published on Nov. 28, 2000); flame-blocking blends for textile fabrics are also known, which are made of inherently flame-blocking fibers and cellulose fibers that, cheaper and softer than the previous ones, have however to be made fireproof by treatment with phosphorus-base compounds (see, for instance, U.S. Pat. No. 6,547,835 in the name of SOUTHERN MILLS INC.—U.S.A. granted on Apr. 15, 2003); furthermore, nitrogen- and phosphorus-containing compositions are known, which can be used for the finishing treatment fitted to make materials fireproof, also made of non-woven fabric, comprising cellulose fibers in case blended with polyester fibers (see, for instance, RU patent application no. 2212481 in the name of INST. KHIM RASTVOROV RAN/OOO APOTEKS-RU published on Sep. 20, 2003 and US patent application no. 2004/0002559 in the name of CIBA SPECIALTY CHEMICALS CORPORATION—U.S.A. published on Jan. 1, 2004). All kinds of products previously listed have the drawback that additional components have to be provided for the cellulose fibers and/or treatment of the sames with appropriate products so to acquire fireproof properties, though not meeting the requirements of TB 603 regulations; furthermore, in most of the products disclosed in the above-mentioned documents, the cellulose fibers are generally present in a not prevailing amount with respect to the other components.

### SUMMARY OF THE INVENTION

The object of the present invention is therefore to overcome the above-mentioned limitations of the solutions disclosed by the prior art, so allowing to obtain better results in terms of fireproof properties and to achieve a more efficient way of applying the fireproof material.

More in detail, the object of the present invention is to supply a new material having fireproof properties improved with respect to the fireproof materials according to the prior art, and in particular such as to comply with TB 603 regulations.

Another object of the present invention is to achieve a more effective performance in mattresses applications, by using the new fireproof material as cover of the sames, with respect to the solutions adopted by the prior art that provide the use of a known fireproof material as intermediate barrier layer between the stuffing and the outer covering.

A further object of the invention is to supply a method of manufacturing the new fireproof material.

A further object of the invention is to simplify and to make cheaper the method of manufacturing the new fireproof material used as mattress cover with respect to methods according to the prior art. These and other objects are obtained with the fireproof non-woven fabric containing cellulose fibers, with the method of manufacturing said fireproof non-woven fabric and with the use of said fireproof non-woven fabric as mattress cover according to the invention, as claimed in the appended claims.

Advantageously, the fireproof non-woven fabric containing cellulose fibers according to the invention allows to obtain better results in terms of fireproof properties such as to comply with TB 603 regulations.

Furthermore, advantageously, the use of said fireproof non-woven fabric according to the invention as mattress cover allows to avoid using an intermediate layer between the stuffing and the outer covering, thereby achieving an even more effective performance with respect to the use of known fireproof materials according to the prior art in mattresses applications.

Advantageously, is furthermore possible to obtain a simplification and a reduction in economic terms of the method of manufacturing the fireproof non-woven fabric according to the invention because this fabric is directly used as mattress cover.

Further features and advantages will become evident from the description of a preferred embodiment of the present invention, which will be now disclosed in detail with reference to a case sample and also with reference to the attached figure, given by way of non limiting example.

### BRIEF DESCRIPTION OF THE FIGURE

FIG. 1 schematically shows a cross section of a mattress covered with the fireproof non-woven fabric according to the present invention.

### DESCRIPTION OF THE INVENTION

The invention substantially resides in a non-woven fabric comprising a blend of cellulose fibers, preferably viscose fibers, and, optionally, synthetic fibers, preferably polyester fibers, said fibers being stitchbonded with synthetic yarns, preferably made of polyester, and said non-woven fabric being subjected to fireproofing treatment by impregnation with a fireproof agent.

Commercially available non-woven fabrics that, conveniently treated to be made fireproof, meet the requirements of regulations, such as for instance British regulations BS 7177, less strict than reference TB 603 regulations, usually consist of 75% by weight of synthetic fibers, generally made of polyester, and of 25% by weight of cellulose fibers, generally made of viscose.

Polyester fibers are particularly appropriate because they are economically convenient and because they are inherently fireproof (as a matter of fact, they burn, or better melt, at very high temperatures, of about 250° C.).

The applicant, in the attempt to find a solution satisfactorily meeting the requirements of TB 603 regulations, deemed it to be reasonable to increase the synthetic fibers content; these synthetic fibers, however, have the drawback, by burning, to shrink and to leave, therefore, “holes” in the material, where fire can find free access to spread. Subsequently, the applicant carried out further attempts by using, in blend with cellulose fibers, inherently fireproof synthetic fibers such as 2612.03 TREVIRA® CS fibers manufactured by BASF AG-DE; also this kind of blend proved to be not fit for the mandatory requirements of TB 603 regulations because, when in contact with flame, it originated “holes” so allowing the flame itself to propagate inside the mattress too.

Moreover, always in the viewpoint to find a solution meeting the requirements of TB 603 regulations, attempts have been carried out by using fireproof viscose and, more in detail, VISCOSE FR manufactured by CHEMIEFASER LENZING AG-AT, also previously cited by commenting upon the known prior art; the use of this fiber, too, allowed the production of openings for fire diffusion, not appearing to be, therefore, suitable for the predetermined purpose.

Finally, surprisingly, it has been found out that, by increasing the cellulose component of the fibers, up to completely eliminating the polyester fibers, the non-woven fabric can absorb, by immersion in a foulard bath, a considerable amount of fireproof agent and thus acquires fireproof properties such as to comply with TB 603 regulations.

As a matter of fact, it has been observed that the cellulose fibers are able to create chemical-physical bonds with the fireproof agent that allow the greatest absorption of this agent and result, therefore, to be the most suitable fibers for getting through the above-mentioned TB 603 regulations; such cellulose fibers, then, in contact with heat or flame carbonize, but they do not shrink and they generate a continuous layer of material that forms a fireproof barrier; on the contrary, as already mentioned, the synthetic fibers, even being inherently fireproof, give no aid because, being fireproof, they do not burn but, for heat effect, they shrink and so create empty areas, making the fireproof barrier effect to fail.

The non-woven fabric according to the present invention is preferably a single layer fabric, but formulations and alternative embodiments that provide for multi-layer realizations are not excluded from the scope of the present invention, as it will be evident to the person skilled in the art. The considered cellulose fibers are preferably viscose fibers having the following physical features:
length preferably comprised between 38 and 120 mm;
diameter preferably comprised between 0.8 and 6.0 denier.

Such viscose fibers, in a preferred embodiment, are formed by about 50% of viscose flock and by about 50% of frayed viscose.

Other cellulose fibers, such as for instance the acetate fibers, can be similarly used, only by conveniently adjusting the fireproof agent concentration.

The considered synthetic fibers, optionally blended with the cellulose fibers, are preferably polyester fibers having the following physical features:
length preferably comprised between 38 and 120 mm;
diameter preferably comprised between 0.8 and 6.0 denier.

The polyester fibers, alternatively, can be polyamide, polyethylene, polypropylene, acrylic or other fibers.

The ratios between cellulose fibers and synthetic fibers are variable, respectively, between 95% and 100% and between 5% and 0%, so as to obtain a range of non-woven fabrics that can vary from a non-woven fabric with fireproof properties narrowly complying with TB 603 regulations (in the case of cellulose and synthetic fibers blend, these latters can shrink for heat effect and cause empties in the fireproof barrier layer) but optimized in economic terms since it also comprises the synthetic fibers that are more easily available on the market and less expensive than the cellulose fibers, to a non-woven fabric broadly meeting the requirements of TB 603 regulations but without maximizing the composition cheapness.

It is to be noticed that, according to a preferred embodiment, the fibers blend according to the invention provides the following composition: 50% by weight of viscose flock, 47.5% by weight of frayed viscose and 2.5% by weight of synthetic fibers. More in general, the amount of cellulose fibers forming the non-woven fabric according to the invention will be preferably higher than 97% by weight while the amount of synthetic fibers optionally present in the non-woven fabric according to the invention will be preferably lower than 3% by weight.

The percent values mentioned above are calculated on the basis of the pure fibers blend and are therefore exclusive of the amount of synthetic yarns used for stitchbonding.

The considered synthetic yarns, used to stitchbond the aforesaid fibers, are preferably polyester yarns having the following physical features:
yarn count preferably of 78/36 dtex;
continuous filament yarn.

Such synthetic yarns form about from 9% to 15% by weight of the fireproof non-woven fabric as final product, i.e. already impregnated with the fireproof agent.

The fireproof agent used to impregnate the non-woven fabric according to the invention is a fireproof agent for cellulose fibers and blended cellulose/synthetic fibers, consisting of an aqueous solution containing at least a phosphorus salt, such as for instance a phosphate, and a nitrogen salt. Preferably the used fireproof agent is a basic aqueous solution, whose pH is basic and preferably of about 8.0; this chemical feature comes from the need of having a fireproof agent not corrosive for the springs and/or for the support metallic net, when they are in direct contact with the mattress cover.

In a preferred embodiment of the present invention, a commercial chemical compound named “APYROL DP” and manufactured by CHT R. BEITLICH GmbH-DE is used as fireproof agent; other commercial products that can be similarly used in the present invention are, for instance, “PIROFLAM” manufactured by Lamberti S.p.A.-IT, “AFLATEX” manufactured by Prochimica Novarese S.p.A.-IT, “PRAYPOL” manufactured by Prayon SA-BE and “NP/N” manufactured by Soft Chemicals.

It has been found out that for the use according to the invention a concentration of the “APYROL DP” agent in the foulard vats variable between 250 g/l and 350 g/l, preferably of about 280 g/l, is needed, such concentration being equivalent to an amount of fireproof agent, as dry product, varying between 17 and 19 g for 1 m² of single layer non-woven fabric; with concentrations lower than 250 g/l the non-woven fabric is not able to comply with TB 603 regulations while with concentrations higher than 350 g/l the non-woven fabric performance gets worse since, when subjected to flame, it dries up and breaks up.

The fireproof agent used to impregnate the non-woven fabric according to the invention acts in the following way: it fully soaks the fibers and afterwards, during the drying step, nitrogen and phosphorus salts remain both inside said fibers and laid down onto the superficial layer of the sames, said salts being responsible of the flame propagation blocking action; the volatile portion, substantially consisting of water and ammonia, evaporates due to heat and is then removed through systems known to the person skilled in the art.

The method of manufacturing the non-woven fabric according to the invention comprises the steps of:
providing an appropriate amount of cellulose fibers and in case of synthetic fibers; for manufacturing, for instance, 1 m² of single layer non-woven fabric, from 135 to 150 g of cellulose fibers and from 15 to 0 g of synthetic fibers will be needed, depending on that blends of cellulose and synthetic fibers or cellulose fibers only are used;
opening, blending and making dense said cellulose fibers so as to create a homogeneous whole or, in case, preparing a homogeneous blend of said cellulose and synthetic fibers;
carding the homogeneous blend so prepared;
stitchbonding said homogeneous blend of fibers at loom with synthetic yarns, thus obtaining a raw non-woven fabric;
mirroring and thermosetting the raw non-woven fabric so obtained;
in case, dyeing and/or printing the non-woven fabric so as to give it a color and/or a decorative pattern;
carrying out the fireproof treatment of the non-woven fabric by impregnation with the fireproof agent, such impregnation occurring owing to the immersion of the non-woven fabric in a foulard bath;
drying the non-woven fabric become fireproof;
carrying out the final mirroring.

By opening, blending and making dense the fibers an operation is meant intended to obtain a sufficiently homogeneous whole, i.e. without gathered fibers agglomerates, also characterized by an almost constant average density.

By carding the homogeneous blend of fibers an operation is meant fitted to obtain fibers separated and oriented in the same direction and carried out by means of cards according to technologies well known in the textile field.

By stitchbonding the homogeneous blend of fibers an operation is meant carried out by means of looms to produce the non-woven fabric according to a technology well known in the textile field.

By mirroring and thermosetting the raw non-woven fabric an operation is meant of checking and setting at a convenient temperature.

By fireproofing the raw non-woven fabric by impregnation with fireproof agent a foulard operation is meant, i.e. an immersion of said raw non-woven fabric in proper vats containing said fireproof agent; the foulard operation, well known in the textile field, usually serves to obtain a starching or a soft dyeing of the treated material. In order to facilitate the fireproof agent penetration inside the non-woven fabric and therefore to prevent said fabric from acquiring fireproof properties only on the superficial layer with which the fireproof agent comes into contact at first, according to the present invention the non-woven fabric is maintained into the foulard vats for a time period variable about between 10 and 20 minutes, preferably for about 15 minutes; if it is deemed to be necessary either to make the fireproofing operation faster or to ensure the adhesion uniformity of the fireproof agent to the non-woven fabric, the vats can be in case subjected to mixing, for instance by means of an inert gas stream.

By drying the non-woven fabric become fireproof an operation is meant during which the non-woven fabric is dried, for instance under inert gas heated stream; consequently, the nitrogen and phosphorus salts forming the fireproof agent lay down and remain fastened inside the non-woven fabric and onto the superficial layer of the same, thus giving it the required fireproof properties, while the volatile portion, substantially consisting of water and ammonia, evaporates as the temperature increases and is then removed.

By final mirroring an operation is meant during which the quality check of the non-woven fabric and its lotting for logistic reasons depending on the client's needs are carried out.

As far as the use of the preferably single layer fireproof non-woven fabric according to the invention as mattress cover is concerned, the manufacturing step in addition to the manufacturing steps listed above will substantially consist in dyeing the obtained non-woven fabric, in printing and/or in superficially processing it for the creation, for instance, of a certain geometrical, floral or the like decorative pattern, and in finishing it to give the final product those features, mainly visual and tactile, that make it suitable for its use.

From a realization standpoint, implementation of the present invention can take place also in an existing plant through possible simple plant modifications, which substantially provide for conveniently adapting the foulard vats so to make them usable in the presence of the fireproof agent.

Since the method according to the present invention employs technologies and equipment known to the person skilled in the art, said technologies and equipment will not be described in detail.

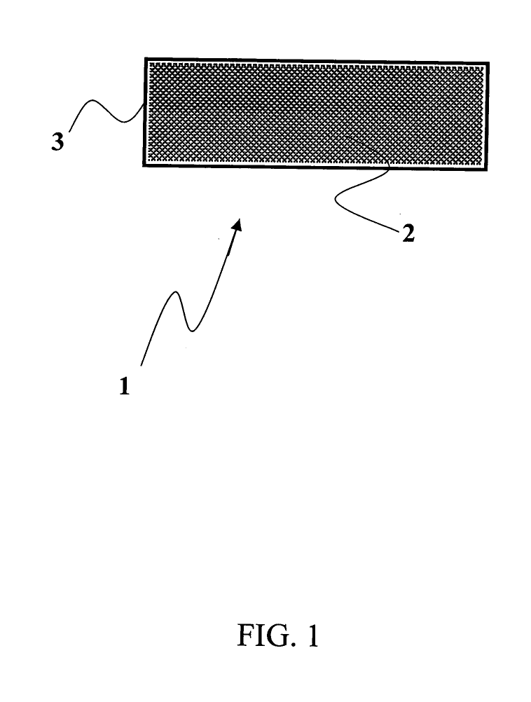

In relation to the use of the fireproof non-woven fabric according to the present invention as mattress cover and with reference to FIG. 1, which schematically shows a cross section of a mattress covered with said fireproof non-woven fabric, it can be seen that mattress 1 is formed by an internal stuffing 2 made of a flexible foam material, for instance polyurethane; even though referring, in the present description, to the aforesaid stuffing, it is possible to use other kinds of mattresses such as, for instance, spring or latex mattresses.

Always with reference to FIG. 1, it is seen that the cover 3, consisting of a single layer of the fireproof non-woven fabric according to the invention having a thickness variable between 0.5 and 1 mm, preferably 0.7 mm, is directly located onto the stuffing 2, such cover 3 adhering to the stuffing 2 so as to prevent as much as possible the formation of wrinkles.

Since the manufacturing for covering a mattress by using the fireproof non-woven fabric according to the present invention employs technologies and equipment known to the person skilled in the art, said technologies and equipment will not be described in detail.

In order to verify the correspondence to the requirements of TB 603 regulations, experimental tests have been furthermore carried out at a certified Laboratory; in particular, it has been seen that for a non-woven fabric according to the invention having a composition containing 50% of viscose flock, 47.5% of frayed viscose and 2.5% of synthetic fibers and being impregnated with “APYROL DP” fireproof agent, a fire resistance higher than the thresholds imposed by the aforesaid regulations is obtained.

As far as more in detail the experimental tests are concerned, they have been carried out according to the procedures prescribed by TB 603 regulations by using a test sample made as follows; it is to be noticed that the indicated amounts are those needed to obtain 1 m² of a single layer fireproof non-woven fabric:

| | | |
|---|---|---|
| viscose fibers | 135 | g |
| polyester fibers | 15 | g |
| polyester yarns | 20 | g about |
| fireproof agent | 18 | g |

The sample has been used to produce a mattress cover having a thickness of about 0.7 mm and it has been directly laid onto a stuffing of the standard commercially available kind.

More precisely, two kinds of mattress have been tested:

the first tested mattress was formed by a stuffing made of a polyurethane flexible foam material CM type fire resistant with high fireproof performance (“CRIB FIVE”), having a density of 35 kg/m³, covered by a fireproof non-woven fabric formed by 100% of viscose and having a weight of 140 g/m²;

the second tested mattress was formed by a stuffing made of a polyurethane flexible foam material of the fire resistant type, cheap basic model, having a density of 35 kg/m³, covered by a fireproof non-woven fabric formed by 100% of viscose and having a weight of 140 g/m².

Tests have been carried out on mattress models as described above, prepared by the Laboratory at the moment of the tests themselves by wrapping each of the two kinds of stuffing, in the form of a slab of flexible foam, with a single layer of non-woven fabric.

The non-woven fabric was laid onto each foam slab so as to adhere and to prevent as much as possible the formation of wrinkles.

The non-woven fabric edges have been closed by means of metallic staples on three sides of the foam slab. All the materials have been conditioned as requested by TB 603 regulations before preparing the sample. Tests have been carried out as requested by the above-mentioned regulations; in particular, the side burner has been located at the side of the mattress model not containing the metallic staples.

The results evaluation procedure has been carried out by comparing with the values reported in the above-mentioned TB 603 regulations, set out in the following tables:

Mattress model with stuffing made of a polyurethane
flexible foam material CM type fire resistant with
high fireproof performance (“CRIB FIVE”)

| | FOUND | REQUESTED VALUE |
|---|---|---|
| PARAMETER | VALUE | BY TB 603 |
| Heat release | <1 | <200 |
| maximum (peak) | | |
| rate [kW] | | |
| Total heat | <0.5 | <25 |
| developed in the | | |
| first 10 min. | | |
| [MJ] | | |

Mattress model with stuffing made of a polyurethane
flexible foam material of the fire resistant type,
cheap basic model

| | FOUND | REQUESTED VALUE |
|---|---|---|
| PARAMETER | VALUE | BY TB 603 |
| Heat release | <1 | <200 |
| maximum (peak) | | |
| rate [kW] | | |
| Total heat | <0.5 | <25 |
| developed in the | | |
| first 10 min. | | |
| [MJ] | | |

It is to be noticed that the heat release maximum (peak) rate, expressed in [kW], and the total heat developed in the first 10 min., expressed in [MJ], are exclusive of the burners contribution.

As it is seen, the obtained results have been extremely satisfying, given that the tested material fire resistance resulted by far higher than that requested by TB 603 regulations.

The experimental tests carried out have been therefore proved that the fireproof non-woven fabric according to the present invention has improved fireproof properties, and in particular such as to comply with TB 603 regulations, also achieving an economic saving thanks to the use of common materials and to a simplified manufacturing process as well as to the elimination of the intermediate layer.

Though the invention has been illustrated with reference to a preferred embodiment, it is in general susceptible of other applications and modifications that are meant to be comprised within the protective scope.

In particular, the use of the fireproof non-woven fabric according to the invention as mattress cover has been illustrated, but it could be as much as usefully employed for covering furniture, such as for instance armchairs and sofas, as well as for producing curtains and wallpaper, as it will be evident to the person skilled in the art.

1. A fireproof non-woven fabric comprising:
cellulose fibers;
optionally synthetic fibers;
synthetic yarns; and
at least a phosphorus and nitrogen salts base fireproof agent;
said cellulose fibers and said synthetic fibers forming a blend wherein the ratios between cellulose fibers and synthetic fibers are variable, respectively, between 95% and 100% and between 5% and 0% by weight with respect to the blend, and being impregnated with said fireproof agent;
the non-woven fabric having fireproof properties such as to comply with TB 603 regulations issued by the State of California, U.S.A., namely, being characterized by a heat release maximum (peak) rate lower than 200 kW and by an amount of total heat developed in the first 10 minutes lower than 25 MJ.

2. The fireproof non-woven fabric according to claim 1, formed as a single layer fabric.

3. The fireproof non-woven fabric according to claim 1, wherein said cellulose fibers are viscose or acetate fibers.

4. The fireproof non-woven fabric according to claim 1, wherein said synthetic fibers are polyester, polyamide, polyethylene or polypropylene fibers.

5. The fireproof non-woven fabric according to claim 1, wherein said blend of cellulose and synthetic fibers is formed by 50% by weight of viscose flock, 47.5% by weight of frayed viscose and 2.5% by weight of synthetic fibers.

6. The fireproof non-woven fabric according to claim 1, wherein said synthetic yarns are polyester yarns.

7. The fireproof non-woven fabric according to claim 6, wherein said synthetic yarns form from 9% to 15% by weight of the non-woven fabric impregnated with the fireproof agent.

8. The fireproof non-woven fabric according to claim 1, wherein said fireproof agent is a chemical compound comprising an aqueous solution containing at least a phosphorus salt, preferably a phosphate, and a nitrogen salt.

9. The fireproof non-woven fabric according to claim 8, wherein said aqueous solution is basic, with pH 25 preferably of about 8.0.

10. The fireproof non-woven fabric according to claim 8, wherein said fireproof agent has a concentration variable between 250 g/l and 350 g/l, preferably of about 280 g/l, that is equivalent to an amount of such fireproof agent, as dry product, varying between 17 and 19 g for 1 m² of single layer nonwoven fabric.

11. A mattress cover made of a fireproof non-woven fabric comprising a blend of cellulose fibers and synthetic fibers having the following composition:
50% by weight of viscose flock, 47.5% by weight of frayed viscose and 2.5% by weight of synthetic fibers, said fibers blend being stitchbonded with synthetic yarns, and impregnated with a phosphorus and nitrogen salts base fireproof agent having a concentration variable between 250 g/l and 350 g/l, preferably of about 280 g/l, that is equivalent to an amount of such fireproof agent, as dry product, varying between 17 and 19 g for 1 m² of single layer non-woven fabric.

12. The mattress comprising a stuffing and a cover made of a fireproof non-woven fabric according to claim 1.

13. The mattress according to claim 12, wherein said cover is a single layer non-woven fabric provided with fireproof properties such as to comply with TB 603 regulations issued by the State of California, U.S.A., i.e. being characterized by a heat release maximum (peak) rate lower than 200 kW and by an amount of total heat developed in the first 10 minutes lower than 25 MJ.

14. A method of manufacturing a fireproof non-woven fabric comprising the steps of:
providing an amount of cellulose fibers comprised between 95% and 100% by weight;
optionally providing an amount of synthetic fibers comprised between 5% and 0% by weight;
opening, blending and making dense said cellulose fibers so as to create a homogeneous whole or, optionally, preparing a homogeneous blend of said cellulose and synthetic fibers;
carding the homogeneous blend so prepared;
stitchbonding said homogeneous blend of fibers at loom with synthetic yarns, thus obtaining a raw non-woven fabric;
mirroring and thermosetting the raw non-woven fabric so obtained;
carrying out a fireproof treatment of the nonwoven fabric by impregnation with a fireproof agent, such impregnation occurring owing to the immersion of the non-woven fabric in a foulard bath;
drying the non-woven fabric;
carrying out the final mirroring.

15. The method according to claim 14 further comprising the step of:
dyeing and/or printing the raw non-woven fabric so as to give it a color and/or a decorative pattern, before carrying out the fireproof treatment.
